(19) United States
(12) Patent Application Publication
(10) Pub. No.: US 2004/0125778 A1
(43) Pub. Date: Jul. 1, 2004

(54) Method and system for improving transmission efficiency of wireless local area network

(75) Inventors: Yeong-shuenn Lin, Hsinchu (TW); Wei-jen Huang, Hsinchu (TW); Tse-hung Chu, Hsinchu (TW); Teng-chou Chang, Hsinchu (TW)

Correspondence Address: BACON & THOMAS, PLLC, 625 SLATERS LANE, FOURTH FLOOR, ALEXANDRIA, VA, 22314

(73) Assignee: NewSoft Technology Corporation, Taipei (TW)

(21) Appl. No.: 10/376,481

(22) Filed: Mar. 3, 2003

(30) Foreign Application Priority Data
Dec. 26, 2002 (TW) 91137577

(51) Int. Cl. H04J 3/00

(52) U.S. Cl. 370/338

(57) ABSTRACT

A method for improving transmission efficiency of wireless local area network (WLAN) comprises a WLAN neighbors establishing procedure and a high efficiency transmission mode establishing procedure. The WLAN neighbors establishing procedure establishes neighbors between stations of the WLAN. The high efficiency transmission mode establishing procedure causes the stations to disassociate with the access point in a power save mode and switch from an infrastructure mode to an ad-hoc mode for transmitting data. The present invention also discloses a corresponding system of improving transmission efficiency of WLAN.

### BACKGROUND OF THE INVENTION

1. Field of the Invention

This invention relates to a method and system for wireless local area network (WLAN) transmission and, more particularly, to a method and system for improving transmission efficiency of WLAN.

2. Description of the Related Art

In a typical wireless network environment, a communication device, such as a computer, needs only to be equipped with an antenna or a wireless network card for connecting to the Internet through a wireless access point (AP). Because of high scalability and easy administration, the WLAN costs little for increasing a number of APs for wireless communication without implementing and expanding cables. Therefore, the operating cost for the WLAN significantly lowers, especially in system installation and maintenance. Besides, the WLAN has more advantages than a wired network in both convenience of network installation and mobility of its use. Therefore, the WLAN technology is most suitable for places where are hard-to-wire and require no physical infrastructure of LAN, such as an exhibition field with temporary network installation, a historical building worth preserving, or an office or a house with decoration, etc.

The current WLAN standard, such as IEEE 802.11, specifies two ways of configuring transmission structure: an ad-hoc mode as shown in FIG. 1a, and an infrastructure mode as shown in FIG. 1b. In the ad-hoc mode, a station (STA) communicates with other STAs using a wireless network card and forms a network. In this mode, however, the STAs are limited to communicate within the LAN and cannot be connected to the Internet. In order to connect to the Internet 107, it is necessary to use the infrastructure mode. In this mode, the STAs 101, 102, and 103 form a network with each other and are connected to a wired network 106 such as an Ethernet through an access point 104 (AP), and further connected to the Internet 107 through a gateway 105 on the wired network 106. The AP 104 therefore functions as a bridge between the STAs and the main network. However, transmission efficiency in the infrastructure mode is reduced since the STAs 101, 102, and 103 need the AP 104 as a bridge for connecting to the Internet 107 and communications between the STAs 101, 102, and 103 are also transmitted through the AP 104.

In the ad-hoc mode, for example, the STA 101 transmits data directly to STA 102 (as shown in FIG. 1a). In the infrastructure mode, however, the STA 101 must transmit data to the AP 104 at first, and then from the AP 104 to the STA 102 (as shown in FIG. 1b). Therefore, for transmitting the same amount of data between the STAs, the infrastructure mode takes twice of the transmission time in the ad-hoc mode, causing the reduction of the transmission efficiency.

Moreover, in the infrastructure mode, each station must wait for polling from the AP or compete for transmission priority in order to transmit data. Consequently, the STAs are in a waiting status most of the time. This is unfavorable for certain applications for the Internet services, such as real-time digital videos. To ensure an effective transmission of a real-time video, the best way is to transmit data in the ad-hoc mode. However, once the transmission mode is selected as the ad-hoc mode, the user must change the setting manually and the AP does not reserve the data transmitted from the Internet to the STAs since the STAs are disassociated with the AP. Also, the STAs cannot use services provided by the AP and lose the connection with the Internet. To sum up, the major challenge faced today is to keep the STAs connected with the Internet and achieve improved transmission efficiency among the STAs, thereby ensuring the transmission quality of real-time videos.

### SUMMARY OF THE INVENTION

In view of the above-mentioned problems, an object of this invention is to provide a method and system for improving transmission efficiency of WLAN, which allows stations of a WLAN to keep in connection with the Internet and to improve transmission efficiency between stations as well.

Another object of this invention is to provide a method and system for improving transmission efficiency of WLAN, so that stations can automatically switch from an infrastructure mode to an ad-hoc mode for improving transmission efficiency and connecting to the Internet without manually setting a transmission mode.

In order to achieve the above objects, the method and system for improving transmission efficiency of WLAN according to the invention include a first station and at least a second station. The first station can establish neighbors with the second station of a WLAN and transmit data directly in an ad-hoc mode. The WLAN neighbors establishing procedure includes broadcast a request of establishing neighbors from the first station, the request including a related information of the first station. After receiving the request, the second station sends back a reply of establishing neighbors including a related information of the second station. After receiving the reply of establishing neighbors, the first station retrieves the related information of the second station for recognizing currently active neighbors on the WLAN.

In addition, an access point is used for establishing an infrastructure mode to transmit data between the stations and for providing connections to the Internet. When the first station needs to establish a connection with the second station in a high efficiency transmission mode, a request is sent to the second station for establishing a connection in the high efficiency transmission mode. After receiving a reply from the second station corresponding to the received request of establishing a high efficiency transmission mode, the first station scans for an available frequency f within a predetermined eligible frequency domain to avoid frequencies currently used by the AP and to generate a service set identifier d. The first station then notifies the AP for switching to a power save mode and also switching to an ad-hoc mode in order to establish connection with the second station in a high efficiency transmission mode by using the frequency f and the service set identifier d. The second station also notifies the AP for switching to a power save mode and switching to an ad-hoc mode in order to establish connection with the first station in a high efficiency transmission mode by using the frequency f and the service set identifier d. Once the connection is established, data can be transmitted between the stations. When the transmission is completed, both of the first and second stations send a request to the AP for association and switch back to the original transmission mode.

According to the present invention, when the first station is connected to the second station in the high efficiency transmission mode, data is transmitted in the ad-hoc mode. As a result, the waiting time caused by polling from the AP or competing for transmission priority is prevented. Meanwhile, the frequency used in the high efficiency transmission mode is different from those used by the AP, thereby avoiding interference, effectively improving transmission efficiency, and increasing available bandwidth. Moreover, after the first and second stations are disassociated with the AP in the power save mode, the AP reserves the data transmitted to the first and second stations. When associated with the AP again, the first and second stations can retrieve from the AP those temporarily stored data including data from the Internet. Hence, the first and second stations can still keep the connection with the Internet and miss no information transmitted from the Internet.

### BRIEF DESCRIPTION OF THE DRAWINGS

The above-mentioned and other objects, features, and advantages of the present invention will become apparent with reference to the following descriptions and accompanying drawings, wherein:

FIG. 1a is a schematic diagram showing a conventional WLAN in an ad-hoc mode;

FIG. 1b is a schematic diagram showing a conventional WLAN in an infrastructure mode;

FIG. 2 is a schematic diagram showing a system for improving transmission efficiency of WLAN in an embodiment of the invention;

FIG. 3 is a flow diagram showing steps implemented by a first station in the method for establishing WLAN neighbors in an embodiment of the invention.

FIG. 4 is a flow diagram showing steps implemented by a second station in the method for establishing WLAN neighbors in an embodiment of the invention;

FIG. 5 is a flow diagram showing steps implemented by a first station in the method for establishing connections in high efficiency transmission mode in an embodiment of the invention; and

FIG. 6 is a flow diagram showing steps implemented by a second station in the method for establishing connections in high efficiency transmission mode in an embodiment of the invention.

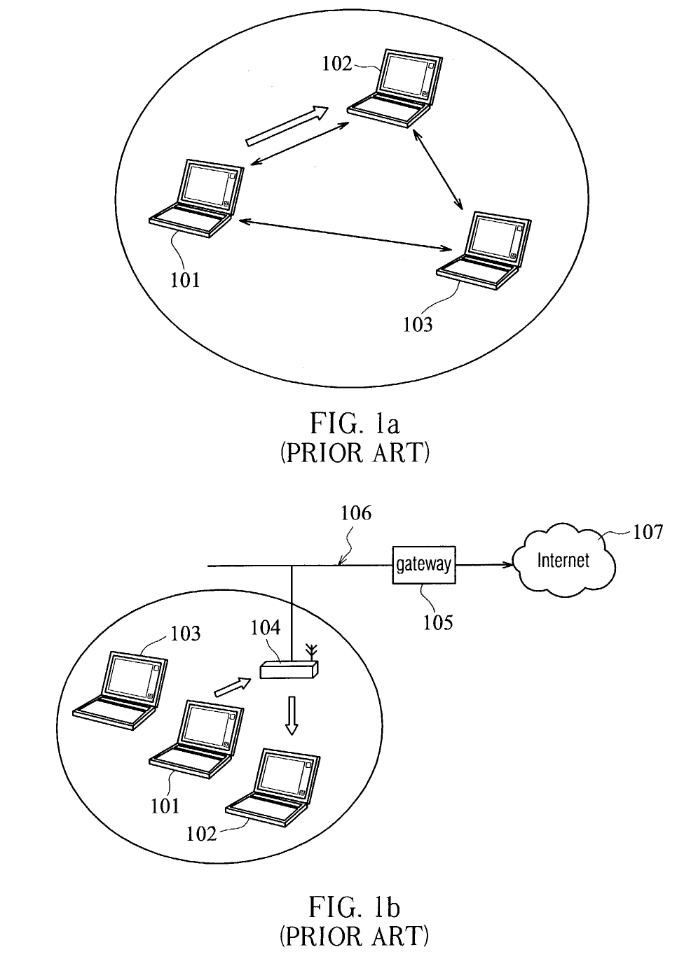

### DETAILED DESCRIPTION OF THE PREFERRED EMBODIMENTS

A method and system for improving transmission efficiency of WLAN according to embodiments of the invention will be described with reference to the accompanying drawings. In the accompanying drawings, similar elements will be denoted with similar reference symbols.

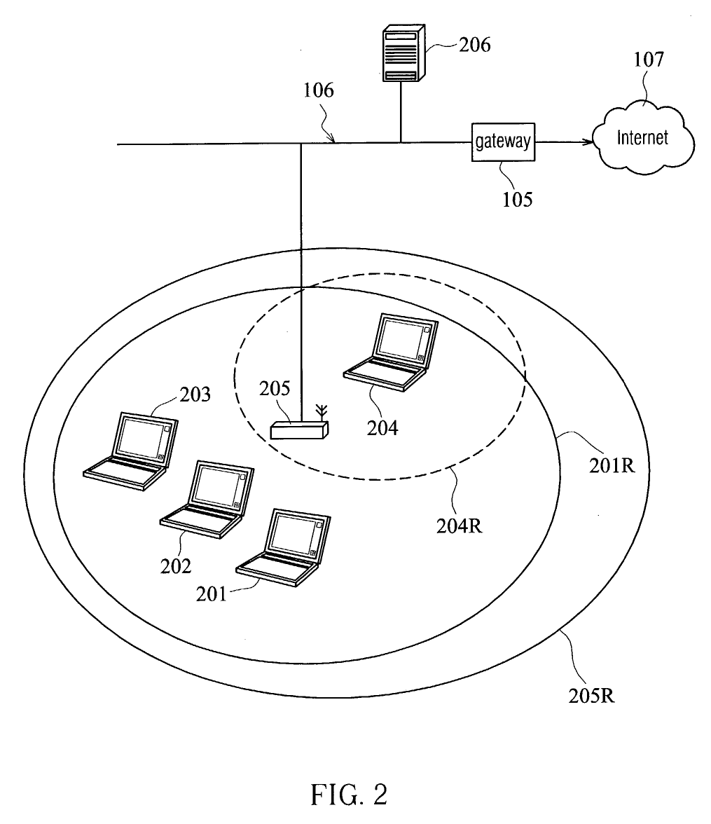

Referring to FIG. 2, a system for improving transmission efficiency of WLAN includes a first station 201 and at least a second station 202, 203. The first station 201 communicates with the second stations 202, 203 based on a conventional transmission standard for WLAN, such as the IEEE 802.11b standard, thereby forming a WLAN in the ad-hoc mode.

In addition, the system further includes an AP 205. The AP 205 communicates with the stations 201, 202, 203 based on the same communication standard of WLAN (IEEE 802.11b), thereby forming a WLAN in the infrastructure mode. In the infrastructure mode, all of the data transmitted between the stations must go through the AP 205 first. Besides, the AP 205 may be connected to a wired network 106, such as an Ethernet. Therefore, through the AP 205, the stations 210, 202, 203 located within the communication range of the AP 205 can get access to data on the wired network 106. For instance, the server 206 shown in FIG. 2 can be a network server such as a file server, a mail server, or a web server. Through the AP 205, each of the stations 201, 202, 203 can also be connected to the Internet 107 via the gateway 105 of the wired network 106.

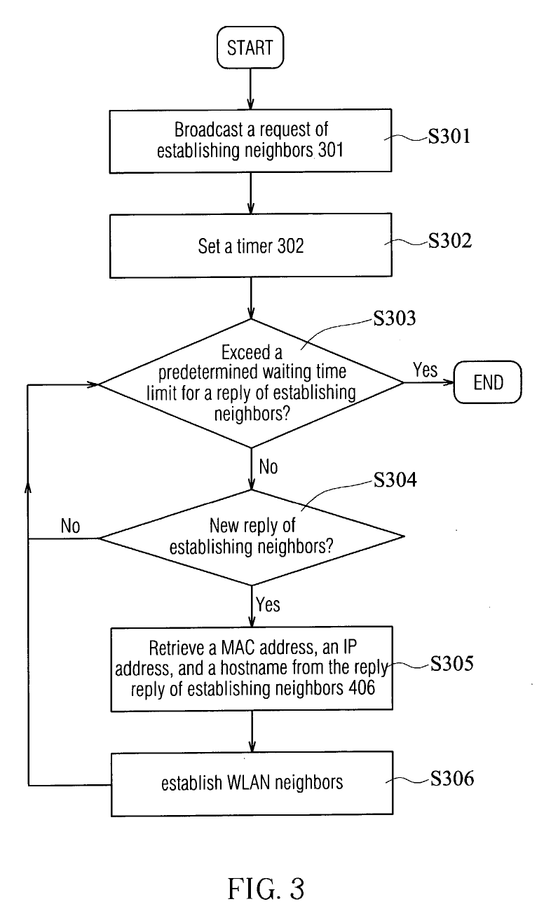

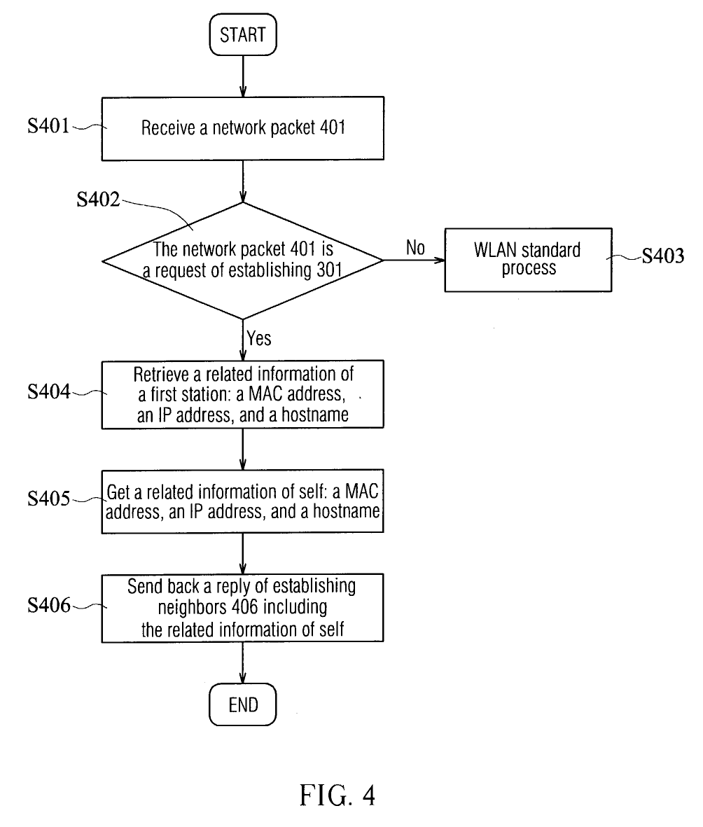

The following description illustrates a method for improving transmission efficiency of WLAN, which is applied to the above-mentioned system. The method includes a procedure for establishing WLAN neighbors and a procedure for establishing a high efficiency transmission mode. The procedure for establishing WLAN neighbors is described in detail with reference to FIGS. 3 and 4. First, as shown in FIG. 3, the first station 201 packs its own related information such as a medium access control address (MAC address), an internet protocol address (IP address) and a hostname as a transmission packet of a lower level communication protocol, such as a medium access control packet (MAC packet), or as a transmission packet of a higher level communication protocol, such as an internet protocol packet (IP packet). Next, the first station 201 broadcasts a request of establishing WLAN neighbors (S301) in compliance with the IEEE 802.11b standard. Thereafter, the first station 201 sets a timer 302 for counting a time of waiting for a reply of establishing neighbors 406 corresponding to the request of establishing neighbors 301. If the counted time of waiting for a reply exceeds a predetermined waiting time limit, the operation of establishing WLAN neighbors is terminated.

Because operations executed by the second station 202 and second station 203 are the same, only the second station 202 is described for illustration. Referring to FIG. 4, when the second station 202 receives a network packet 401 (S401), the second station 202 determines whether the network packet 401 is a request of establishing neighbors 301 (S402). If the network packet 401 is not a request of establishing neighbors 301, the network packet 401 is processed according to the IEEE 802.11b standard (S403). If the network packet 401 is a request of establishing neighbors 301, the related information of the first station 201, i.e. the MAC address, the IP address, and the hostname, is retrieved from the request of establishing neighbors 301 (S404). Subsequently, the second station 202 retrieves its own related information, i.e. the MAC address, the IP address, and the hostname (S405), and sends back a reply of establishing neighbors 406 corresponding to the request of establishing neighbors 301 (S406). The reply of establishing neighbors 406 includes the related information of the first station 201 and the related information of the second station 202.

Referring back to FIG. 3, during the waiting for a reply of establishing neighbors 406 (S303), the first station 201 receives and determines whether a reply of establishing neighbors 406 is new. If the reply of establishing neighbors 406 is not new, the first station keeps waiting until the predetermined waiting time limit is exceeded (S303). If the reply of establishing neighbors 406 is new, the first station 201 then retrieves the related information of the second station 202, i.e. the MAC address, the IP address, and the hostname, from the reply of establishing neighbors 406 (S305). Finally, the first station 201 and the second station 202 are established as WLAN neighbors as requested (S306).

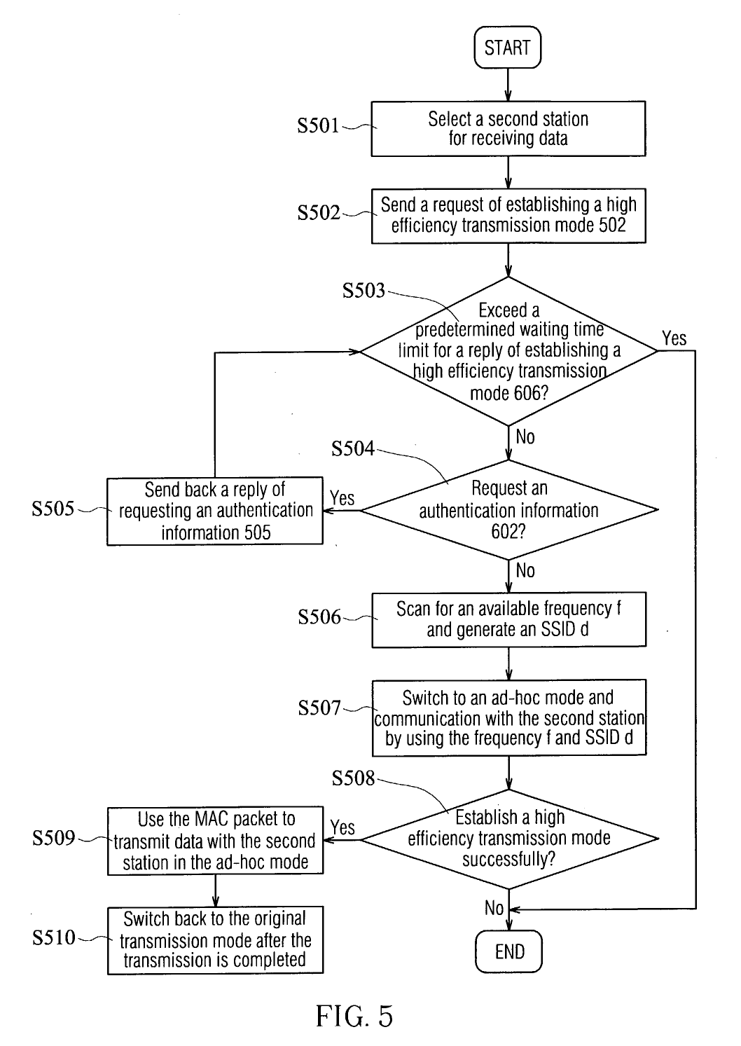

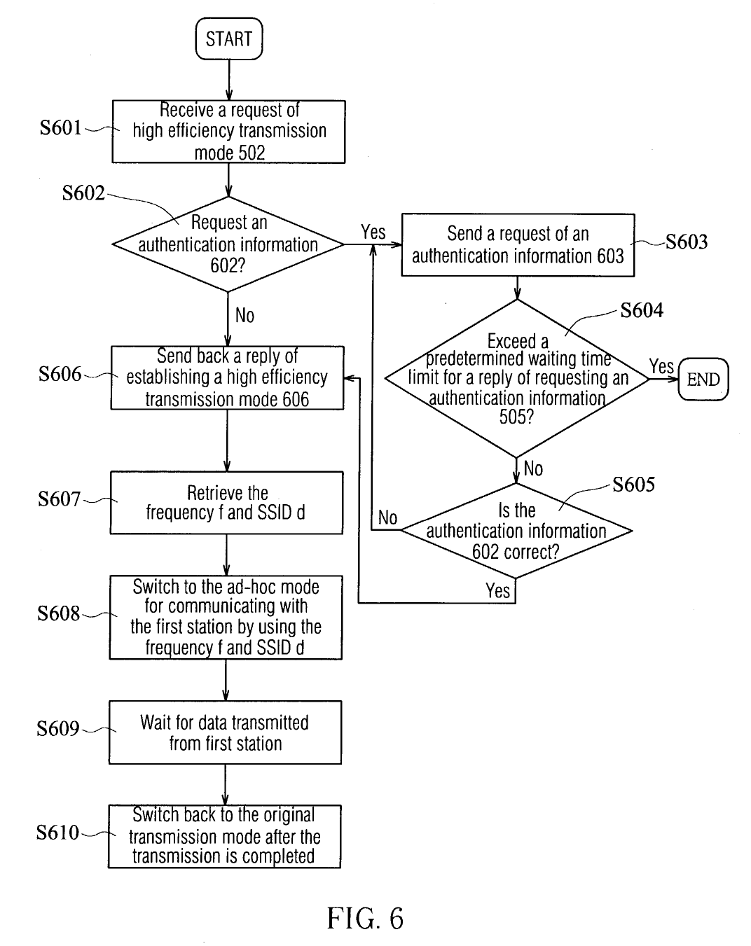

Referring to FIGS. 5 and 6, a procedure for establishing a high efficiency transmission mode is described. As shown in FIG. 5, the first station 201 selects at least a second station 202, 203 from the list of WLAN neighbors for receiving data (S501). Because operations executed by the second station 202 and second station 203 are the same, only the second station 202 is described as an example. Next, the first station 201 sends a request of establishing a high efficiency transmission mode 502 to the second station 202 (S502) and then waits for a corresponding reply (S503). If a time of waiting for the reply exceeds the predetermined waiting time limit, the operation for establishing a high efficiency transmission mode is terminated.

Referring to FIG. 6, after receiving the request of establishing a high efficiency transmission mode 502 (S601), the second station 202 may request for an authentication information 602 from the first station 201 in order to determine whether to accept the request of establishing a high efficiency transmission mode (S602). Examples of the authentication information 602 are a password or a key value for verifying identification and permission. If the authentication information 602 of the first station 201 is required, the second station 202 sends a request of an authentication information 603 to the first station 201 (S603) and then waits for a corresponding reply (S604). If a time of waiting for the reply exceeds the predetermined waiting time limit, the operation for establishing a high efficiency transmission mode is terminated. While the first station 201 is waiting for the reply of establishing a high efficiency transmission mode (S503), because the reply received is a request of an authentication information 603 (S504), as shown in FIG. 5, the step S505 is performed for sending back a reply of requesting an authentication information 505, including the authentication information 602 for passing the authentication of the second station 202. After receiving the authentication information 602, the second station 202 determines whether the authentication information 602 is correct (S605). If the authentication information 602 is incorrect, then the step S603 repeats to send a request of an authentication information 603 in order to request the first station 201 for the authentication information 602 again. The first station 201 executes the step S505 again to send back a reply of requesting an authentication information 505. If the authentication information 602 is correct, then the second station 202 sends back a reply of establishing a high efficiency transmission mode 606 for agreeing the establishment of the high efficiency transmission mode (S606).

After receiving the reply of establishing a high efficiency transmission mode 606, the first station 201 scans for an available frequency f within a predetermined eligible frequency domain to avoid transmission collision and interference. The IEEE 802.11b specifies at least three frequency domains separated at least 20 MHz. Take the standard for North America as an example, the central frequencies of the three frequency domains might be 2412 MHz, 2437 MHz, and 2462 MHz respectively. The first station 201 scans through the three frequency domains, avoiding frequencies currently used by the AP 205 or frequencies having severe interference. This is to avoid transmission collisions or interference. Besides, the first station 201 randomly generates a service set identifier (SSID) d for verification when communicating with the second station 202. The first station 201 notifies the second station 202 about the frequency f and the service set identifier d (S506). Thereafter, the first station 201 reports to the AP 205 that the first station 201 is switched to a power save mode and the transmission mode is switched to the ad-hoc mode, using the frequency f and service set identifier d to establish connections with the second station 202 in the high efficiency transmission mode (S507).

Note that in such a simple environment of WLAN that the first station 201 and the second station 202 can trust each other, the authentication step can be omitted. For example, when the second station 202 receives a request of establishing a high efficiency transmission mode 502, the step S606 is performed to send back a reply of establishing a high efficiency transmission mode 606. After the first station 201 receives the reply of establishing a high efficiency transmission mode 606, the step S506 is performed to scan for available a frequency f and to generate a service set identifier d, and to notify the second station 202.

After receiving the frequency f and the service set identifier d, the second station 202 retrieves the information (S607). Thereafter, the second station 202 reports to the AP 205 that the second station 202 is switched to a power save mode and the transmission mode is switched to the ad-hoc mode, using the frequency f and the service set identifier d to wait for directly establishing a high efficiency transmission mode with the first station 201 to transmit information (S608).

While the first station 201 is trying to establish connections, a timer can be set for counting a time of waiting (S508). If the establishment of connections fails, the operation of establishing a high efficiency transmission mode is terminated. If the connections are successfully established, the information is packed as a MAC packet and transmitted to the second station 202 in the ad-hoc mode (S509). Correspondingly, after the high efficiency transmission mode is successfully established, the second station 202 waits to receive and process the information of the MAC packet (S609). When the data transmission is completed, each of the first station 201 and the second station 202 files an application of association to the AP 205. The transmission mode is then switched back to the infrastructure mode, using the original frequency domain to transmit data (S510 and S610). Since the stations are disassociated with the AP 205 in the power save mode during the establishment of the connections in the high efficiency transmission mode, the AP 205 reserves those data to be transmitted to the stations in the power save mode. After each of the first station 201 and the second station 202 returns to association, the data stored temporarily on the AP 205 is retrieved.

Note that after the first station sends a request of establishing a high efficiency transmission mode to the second station, the first station must receive a reply from the second station. Thus, in order to establish a high efficiency transmission mode, the communication range is a coverage area where the first station can hear information replied by all of the second stations. For example, as shown in FIG. 2, assume that within a communication range 201R of the first station 201, the station 204 can hear, i.e. receive, a request of establishing a high efficiency transmission mode 502 from the first station 201. However, if the station 204 is located in an environment having too much interference, then an effective communication range 204R of the station 204 may be so small that the reply of establishing a high efficiency transmission mode 606 sent by the station 204 cannot be heard by the first station 201. Consequently, the first station 201 cannot establish connections with the station 204 in the high efficiency transmission mode even though both of the first station 201 and the station 204 are located within a communication range 205R of the common AP 205.

In addition, the security setting for data transmission in the high efficiency transmission mode complies with the setting of the original WLAN communication standard. For instance, a Wired Equivalent Privacy (WEP) method is utilized to encrypt transmission data. Because the stations belong to the domain of the same AP, the key used by the WEP method is the same and the verification is not necessary.

According to the invention, the stations in a WLAN can transmit data in the ad-hoc mode in cooperation with the video streaming technology, thereby ensuring the quality of the video. Even if the data is transmitted between the stations in the infrastructure mode, when a larger bandwidth is required, the transmission mode can be automatically switched to the ad-hoc mode in order to establish a high efficiency transmission mode for transmitting data, thereby increasing the available bandwidth. Moreover, since the frequency used to transmit data between the stations is different to the one used by the AP, a possible interference is avoided. Besides, the data transmitted for those stations in the high efficiency transmission mode is temporarily stored in the AP since the stations are disassociated with the AP in the power save mode. These data include not only those transmitted in the WLAN but also those transmitted from the Internet. Therefore, when restoring to in association with the AP, the station can retrieve those data from the AP without losing the connection with the Internet.

While the invention has been described by way of examples and in terms of preferred embodiments, it is to be understood that the invention is not limited to the disclosed embodiments. To the contrary, it is intended to cover various modifications. For example, the IEEE 802.11b standard for WLAN is used for the description of the embodiment of the invention. Those skilled in the art may make alternations and modifications using IEEE 802.11a or other standards relating to IEEE 802.11×standard for WLAN. Therefore, the scope of the appended claims should be accorded the broadest interpretation so as to encompass all such modifications.

What is claimed is:

1. A method for improving transmission efficiency of wireless local area network (WLAN), for improving the transmission efficiency between a first station and at least a second station of a WLAN which complies with a WLAN transmission standard, said WLAN further including at least an access point (AP) capable of connecting with a wired network, said method comprising:
a WLAN neighbors establishing procedure for establishing neighbors between said first station and said second station of WLAN; and
a transmission mode automatically switching procedure for causing a data transmission between said first station and said second station to be automatically switched between an infrastructure mode and an ad-hoc mode.

2. The method according to claim 1, wherein said WLAN neighbors establishing procedure comprises:
broadcasting a request of establishing neighbors from said first station, said request of establishing neighbors including a related information of said first station;
retrieving said related information of said first station after said second station receives said request of establishing neighbors;
sending a reply of establishing neighbors corresponding to said request of establishing neighbors from said second station to said first station, said reply of establishing neighbors including said related information of said first station and a related information of said second station;
retrieving said related information of said second station after said first station receives said reply of establishing neighbors; and
establishing a WLAN neighbors connection between said first station and said second station by using said related information of said second station and said related information of said first station when a data is transmitted between said first station and said second station.

3. The method according to claim 2, wherein, through said AP, said first station uses a medium access control (MAC) packet or an internet protocol (IP) packet for broadcasting said request of establishing neighbors.

4. The method according to claim 2, wherein said related information of said first station includes a MAC address, an IP address, and a hostname.

5. The method according to claim 1, further comprising:
determining whether a network packet received by said second station is a request of establishing neighbors, if yes, sending back a reply of establishing neighbors; if no, processing said network packet according to said WLAN transmission standard; and
determining whether a network packet received by said first station is said reply of establishing neighbors, if yes, retrieving said related information of said second station; if no, processing said network packet according to said WLAN transmission standard.

6. The method according to claim 1, wherein said transmission mode automatically switching procedure comprises:
broadcasting a request of establishing a high efficiency transmission mode from said first station in order to query whether said second station agrees to establish a connection in a high efficiency transmission mode;
sending a reply of establishing a high efficiency transmission mode corresponding to said request of establishing a high efficiency transmission mode from said second station to said first station;
selecting an available frequency and an identifier from said first station so as to notify said second station of said available frequency and said identifier;
filing an application for switching to a power save mode from said first station and said second station to said AP, and switching said data transmission from said infrastructure mode to said ad-hoc mode;
establishing a connection between said second station and said first station by using said available frequency and said identifier selected by said first station to connections;
packing data to be transmitted as a MAC packet and transmitting said MAC packet from said first station to said second station; and
filing an application from said first station and second station to said AP for restoring an association after said data transmission between said first station and said second station is completed.

7. The method according to claim 6, further comprising:
determining whether to accept said request of establishing a high efficiency transmission mode by requiring an authentication information from said first station to said second station.

8. The method according to claim 6, wherein said first station for broadcasting said request of establishing a high efficiency transmission mode has such a broadcast range that said first station can hear an information replied from each of said at least a second stations in said WLAN, said information including at least a MAC address and an IP address.

9. The method according to claim 6, wherein said first station selects said available frequency by scanning a certain frequency domain.

10. The method according to claim 6, wherein said identifier selected by said first station is a unique identifier predefined for each frequency within a certain frequency domain.

11. The method according to claim 1, wherein said data transmission is provided with a security setting in accordance with said WLAN transmission standard used in said WLAN.

12. The method according to claim 1, wherein said WLAN transmission standard is an IEEE 802.11 standard.

13. A system for improving transmission efficiency of WLAN, comprising:
a WLAN established by a first station and at least a second station, in which said first station and said second station transmits data between one another through an interface complying with a WLAN transmission standard, wherein:
said first station selects an available frequency and an identifier to notify said second station;
said second station uses said available frequency and said identifier to establish a connection with said first station in a high efficiency transmission mode; and
said first station packs data to be transmitted as a MAC packet and transmits said packet to said second station.

14. The system according to claim 13, wherein said WLAN further comprises at least an AP capable of connecting with a wired network, wherein:
said first station and said second station files an application to said AP for switching to a power save mode when said connections in said high efficiency transmission mode is to be established;
said first station and said second station switch from an infrastructure mode to an ad-hoc mode for transmitting data; and
said first station and said second station files an application to said AP for restoring an association after said data transmission between said first station and said second station is completed.

15. The system according to claim 13, wherein said second station requires an authentication information from said first station in order to determine whether to accept said request of establishing a high efficiency transmission mode.

16. The system according to claim 13, wherein said first station further executes a WLAN neighbors establishing procedure for establishing neighbors with said second station, said procedure comprising:
broadcasting a request of establishing neighbors from said first station, said request of establishing neighbors including a related information of said first station;
retrieving said related information of said first station after said second station receives said request of establishing neighbors;
sending a reply of establishing neighbors corresponding to said request of establishing neighbors from said second station to said first station, said reply of establishing neighbors including said related information of said first station and a related information of said second station;
retrieving said related information of said second station after said first station receives said reply of establishing neighbors; and
establishing a WLAN neighbors connection between said first station and said second station by using said related information of said second station and said related information of said first station when a data is transmitted between said first station and said second station.

17. The system according to claim 13, wherein said first station selects said available frequency by scanning a certain frequency domain.

18. The system according to claim 13, wherein said identifier selected by said first station is a unique identifier predefined for each frequency within a certain frequency domain.

19. The system according to claim 13, wherein said WLAN transmission standard is an IEEE 802.11 standard.
